(19) United States
(12) Patent Application Publication
(10) Pub. No.: US 2014/0229327 A1
(43) Pub. Date: Aug. 14, 2014

(54) FACILITATING A USER TO PURCHASE MULTIPLE PRODUCTS FROM DIFFERENT SHOPPING SITES

(71) Applicant: ORACLE INTERNATIONAL CORPORATION, Redwood Shores, CA (US)

(72) Inventor: Prateek Khanna, Bangalore, IN (US)

(73) Assignee: Oracle International Corporation, Redwood Shores, CA (US)

(21) Appl. No.: 13/764,792

(22) Filed: Feb. 12, 2013

(51) Int. Cl. G06Q 30/06

(52) U.S. Cl. CPC G06Q 30/0633
USPC 705/26.8

(57) ABSTRACT

An aspect of the present invention facilitates users to purchase multiple products from shopping sites. In an embodiment, a user specifies a list of products and corresponding selection criteria for each product, with the selection criteria for at least two products being different. A corresponding shopping site, satisfying the corresponding selection criteria for each product, is determined. A shopping cart is generated and then provided to the user, with the shopping cart indicating the list of products, the corresponding determined shopping sites and respective commercial terms. Upon a confirmation of the shopping cart, orders are placed for each product at the corresponding determined shopping site.

### BACKGROUND OF THE INVENTION

1. Technical Field

The present disclosure relates to electronic commerce systems and more specifically to facilitating a user to purchase multiple products from different shopping sites.

2. Related Art

A shopping site refers to a website from which users can purchase products electronically. As used herein, a product includes goods and services. Typically a user indicates the products of interests according to a suitable interface, and generally makes a payment using facilities such as credit cards, online banking, payment gateways (e.g., Paypal™ or Google Wallet™) etc.), to complete ordering/purchase of the indicated products. The ordered products are then shipped (made available) to the purchasing user. Occasionally, payments are permitted to be paid later upon receipt of the shipped products, e.g., cash on delivery.

There are often situations when a user may wish to purchase different products, potentially from different shopping sites. It may be desirable to simplify the purchase of multiple products from different shopping sites.

### BRIEF DESCRIPTION OF THE DRAWINGS

Example embodiments of the present invention will be described with reference to the accompanying drawings briefly described below.

FIG. 1 is a block diagram illustrating an example environment in which several aspects of the present invention can be implemented.

FIG. 2 is a flow chart illustrating the manner in which a user is facilitated to purchase multiple products from different shopping sites according to an aspect of the present invention.

FIG. 3A illustrates the manner in which a user is enabled to specify a desired list of products and corresponding (different) selection criteria in one embodiment.

FIG. 3B illustrates the manner in which a user is provided a shopping cart corresponding to a requested list of items and corresponding (different) selection criteria in one embodiment.

FIG. 4 illustrates the manner in which a shopping site satisfying the corresponding selection criteria specified for a product is determined in one embodiment.

FIG. 5 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention facilitates users to purchase multiple products from shopping sites. In an embodiment, a user specifies a list of products and corresponding selection criteria for each product, with the selection criteria for at least two products being different. A corresponding shopping site, satisfying the corresponding selection criteria for each product, is determined. A shopping cart is generated and then provided to the user, with the shopping cart indicating the list of products, the corresponding determined shopping sites and respective commercial terms. Upon a confirmation of the shopping cart, orders are placed for each product at the corresponding determined shopping site.

Accordingly, a user has the convenience of purchasing multiple products of interest from a single request, and yet being able to specify different selection criteria and preferred shopping sites for different products.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

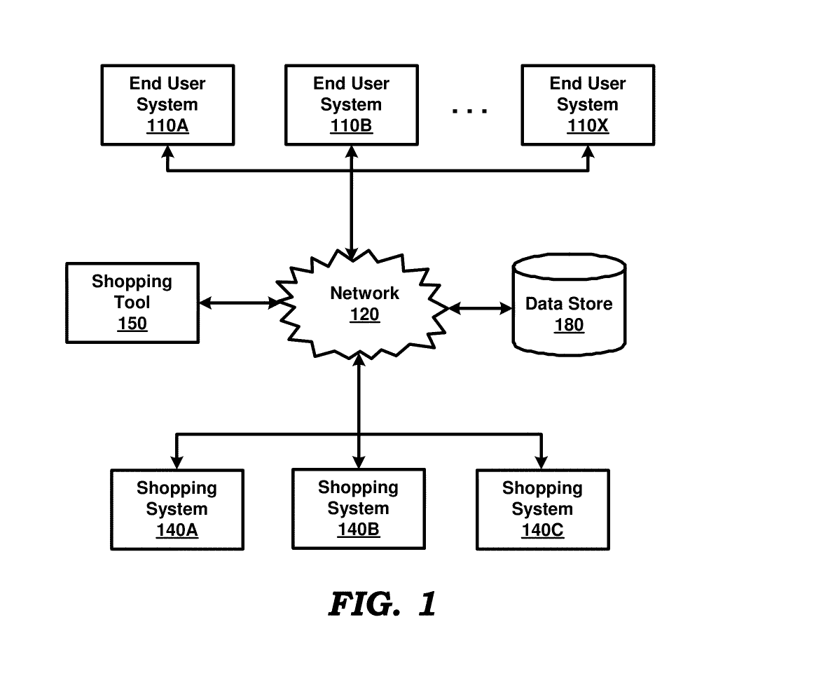

FIG. 1 is a block diagram illustrating an example environment in which several aspects of the present invention can be implemented. The block diagram is shown containing end-user systems 110A-110X, network 120, shopping systems 140A-140C, shopping tool 150 and data store 180.

Merely for illustration, only representative number/type of systems is shown in the Figure. Many environments often contain many more systems, both in number and type, depending on the purpose for which the environment is designed. Each system/device of FIG. 1 is described below in further detail.

Network 120 provides connectivity between end-user systems 110A-110X, shopping systems 140A-140C, shopping tool 150 and data store 180. Network 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the destination system to which the packet is to be eventually delivered.

A (IP) packet is said to be directed to a destination system when the destination IP address of the packet is set to the (IP) address of the destination system, such that the packet is eventually delivered to the destination system by network 120. When the packet contains content such as port numbers, which specifies the destination application, the packet may be said to be directed to such application as well. The destination system may be required to keep the corresponding port numbers available/open, and process the packets with the corresponding destination ports. Network 120 may be implemented using any combination of wire-based or wireless mediums.

Data store 180 represents a non-volatile storage facilitating storage and retrieval of a collection of data (such as the end user specific list of shopping sites, identity data related to the end-users, etc.) by shopping tool 150. The data store may be implemented using relational database technologies and therefore provide storage and retrieval of data using structured queries such as SQL (Structured Query Language). Alternatively, the data store may be implemented as a file store providing storage and retrieval of data in the form of one or more files organized as one or more directories, as is well known in the relevant arts.

Each of end-user systems 110A-110X represents a system such as a personal computer, workstation, mobile station, tablet, etc., used by users to generate (user) requests to applications executing in shopping systems 140A-140C or to shopping tool 150. The user requests may be generated using appropriate user interfaces, for example, web pages provided by the applications. In general, an end user system requests an application for performing desired tasks (such as searching for products, placing orders for one or more products, etc.) and receives corresponding responses containing the results of performance of the requested tasks.

Each of shopping systems 140A-140C represents a set of (one or more) servers, such as a web/application servers, executing applications capable of performing tasks requested by users using end-user systems 110A-110X. Each shopping system provides a corresponding shopping site (in the form of web pages, as is well known) that facilitates end users to purchase desired products offered by the shopping site. The products are often manufactured by other parties/companies, with the shopping systems operating as a vendor of the products.

In general, a shopping system, in response to receiving a user request from an end-user system, performs the tasks specified in the request and sends the result of performance of the tasks to the requesting end user system. The shopping system may use data stored internally (for example, in a non-volatile storage/hard disk within the system), external data (for example, stored in data stores such as 180) and/or data received from external sources (e.g., from the user) in performing such tasks.

It may be appreciated that in the scenario that a user wishes to purchase multiple products, the user is required to access each shopping site individually, search and compare the products offered by each of the shopping sites, and then place orders (for purchasing) for corresponding products from different shopping sites. It may be desirable that such purchasing of multiple products (from multiple shopping sites) be simplified.

Shopping tool 150, provided according to several aspects of the present invention, facilitates a user to purchase multiple products from different shopping sites, as described below with examples.

### 3. Purchasing Multiple Products From Different Shopping Sites

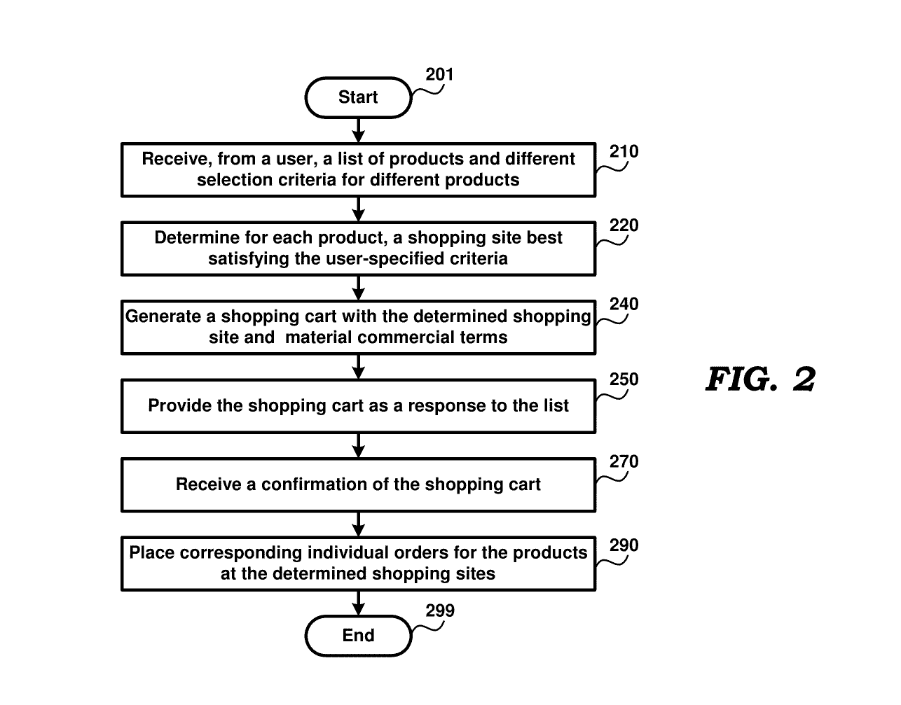

FIG. 2 is a flow chart illustrating the manner in which a user is facilitated to purchase multiple products from different shopping sites according to an aspect of the present invention. The flowchart is described with respect to the systems of FIG. 1, in particular, shopping tool 150, merely for illustration. However, the features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, shopping tool 150 receives, from a user, a list of products and different selection criteria for different products. Selection criteria for a product, specifies the conditions to be used for differentiating among various vendors of the product and different models of the requested product (from same or different vendors). Examples of such conditions include lowest price, highest positive reviews, highest discount, freshest (product offering) first, etc. Thus, by having different selection criteria for different products, a user has the enhanced flexibility to specify criteria appropriate for each product.

In step 220, shopping tool 150 determines for each product, a shopping site best satisfying the corresponding user-specified criteria. Thus, in case multiple shopping sites (vendors) are offering the same requested product, the conditions specified for that product may be used to determine the specific shopping site. The criteria can be used to distinguish between similar products of different manufacturers. Thus, shopping tool 150 may determine different shopping sites as being corresponding suitable vendor/seller of different ones of the list of products.

In step 240, shopping tool 150 generates a shopping cart with the determined shopping site and material commercial terms for the products in the received list. ‘Material commercial terms’ include terms, which would be of immediate/substantial interest for the user/buyer to confirm the purchase. While the example embodiments below are described with only terms affecting total cost (unit price, shipping costs, discounts, etc.) to the user/buyer, alternative embodiments can employ other material factors that could be of interest to the buyers (for purchase decisions) in corresponding environments/situations.

In step 250, shopping tool 150 provides (sends to the requesting end user system) the shopping cart as a response to the list. The shopping cart may accordingly be displayed on a display unit associated with the requesting end user system. In step 270, shopping tool 150 receives from the user/buyer, a confirmation of the shopping cart. Such a confirmation may be received when the user indicates that the user wishes to “check-out”, that is, proceed to payment for the products included in the shopping cart.

In step 290, shopping tool 150 places corresponding (purchase) orders for the products at the determined shopping sites. The orders may be placed using corresponding interfaces provided by each of the determined shopping sites. The user may be required to provide payment information for completing the purchase at each shopping site, or alternatively shopping tool 150 may take payment information from the user and provide the information to each of the shopping sites. The flowchart ends in step 299.

Thus, the user is provided a convenient interface using which different products can be purchased from different shopping web sites. In addition, the user is provided the ability to specify different desired criteria for different products. It may be appreciated that the user sends only a single request with all the desired list of products and different selection criteria for the different products, and receives in response a shopping cart that is ready to be checked-out.

The description is continued illustrating the manner in which shopping tool 150 implements the steps of FIG. 2 to provide several aspects of the present invention.

### 4. Illustrative Example

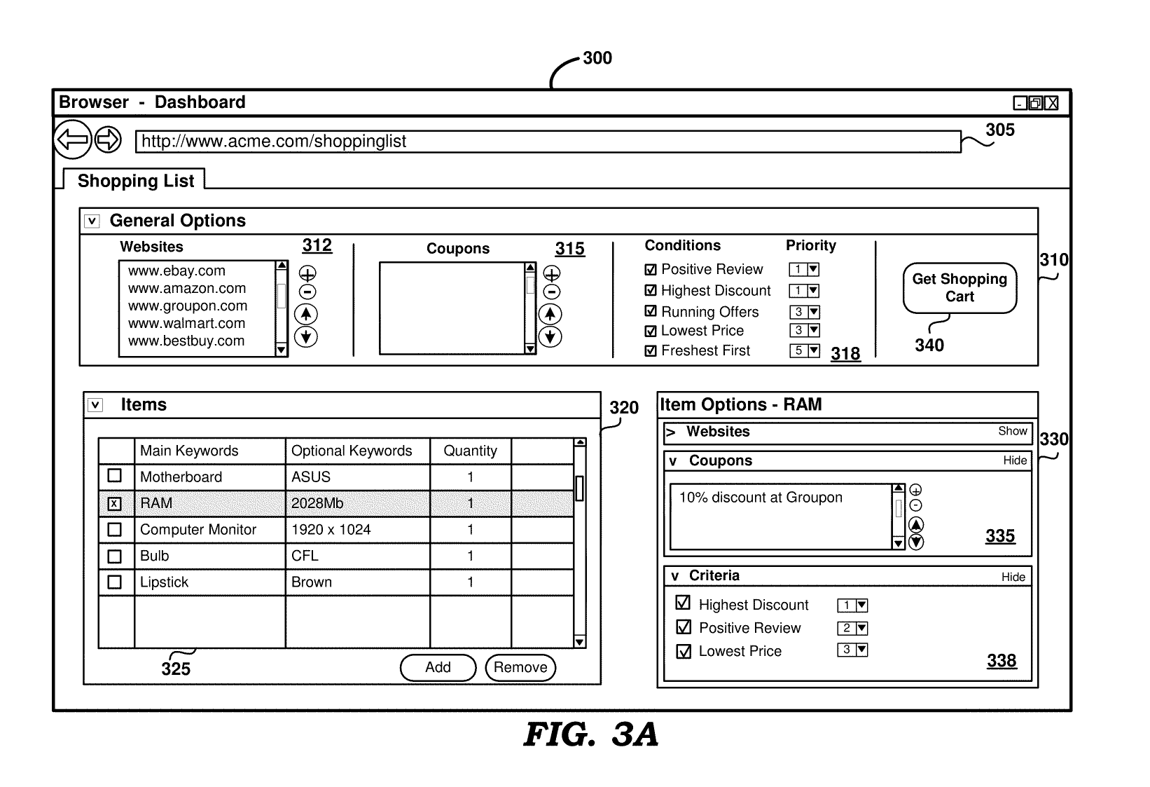

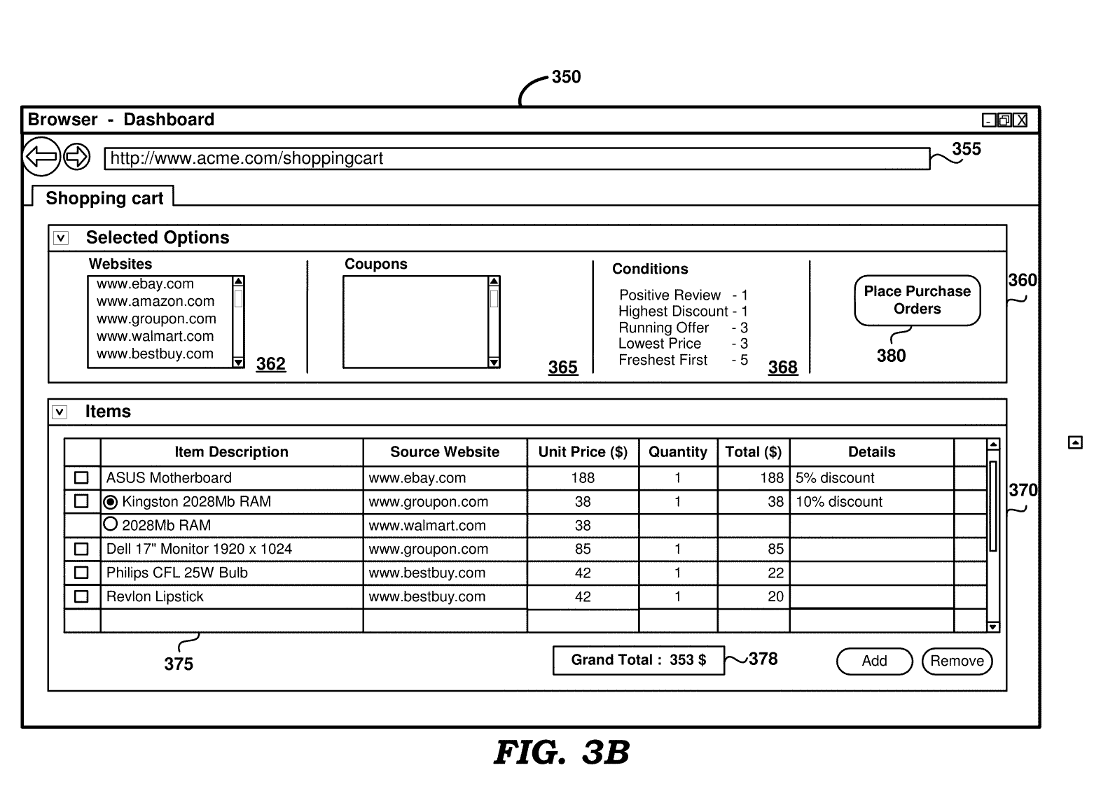

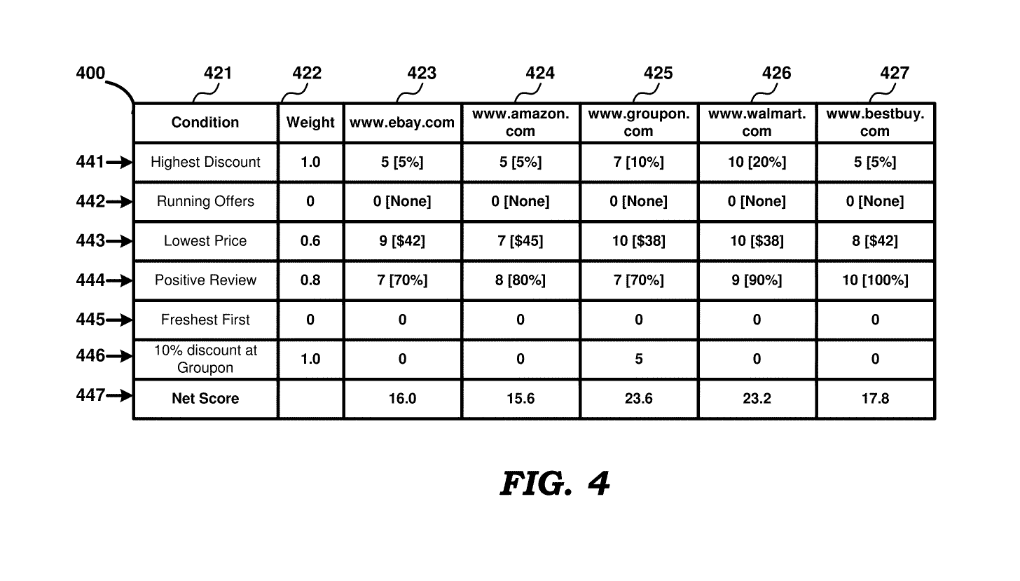

FIGS. 3A-3B and 4 together illustrate the manner in which a user is facilitated to purchase multiple products from different shopping sites in one embodiment. Each of the Figures is described in detail below.

FIG. 3A illustrates the manner in which a user is enabled to specify a desired list of products and corresponding (different) selection criteria in one embodiment. Display area 300 (and also display area 350 of FIG. 3B) depicts a portion of a user interface provided on a display unit (not shown in FIG. 1) associated with one of end user systems 110A-110X (assumed to be 110A for illustration). Display area 300 corresponds to a webpage accessed by the users in response to sending a request (including an identifier of the webpage, as indicated by the text in display area 305) from end user system 110A to shopping tool 150. The web page is received from shopping tool 150 prior to being displayed on the display unit.

Display area 310 (labeled “General Options”) enables a user to specify the desired common criteria applicable to all the items/products sought to be searched/purchased. Such common criteria may be used by shopping tool 150 as a basis for preliminary selection of the shopping sites for each product. In particular, the user is enabled to specify different conditions (forming the selection criteria) based on which the products are sought to be purchased from different sites.

For example, display area 312 enables the user to specify (by using add “+” button and remove “−” buttons) the URLs (uniform resource locators) of the shopping sites of interest. The list of shopping sites shown in display area 312 is according to a descending order/priority in which the shopping sites are to be searched. In other words, display area 312 indicates that the shopping site “www.ebay.com” is to be searched before the site “www.amazon.com”, which in turn should be searched prior to the site “www.bestbuy.com”. The user may change the order of the sites by moving the desired sites in up or down (thereby increasing or decreasing the priority) the list by using the Up and Down button shown in display area 312.

Display area 315 enables the user to specify (by using add “+” button and remove “−” buttons) a list of redeemable coupons that the user may currently possess related to any of the products sought to be purchased. The empty list in display area 315 indicates that the user has not specified any coupons. It may be observed that the list of coupons is also according to a descending/priority order, similar to the list of shopping sites, with the user facilitated to increase/decrease the priority of a coupon using the Up and Down button shown in display area 315.

Display area 318 indicates different conditions such as “Highest Discount”, “Running Offers”, “Positive Review”, etc. that may be selected by the user (using the corresponding check boxes shown there). The user may also select a priority (from 1 to 5, with 1 representing the highest priority and 5 representing the lowest priority) for each of the desired conditions by selecting a corresponding value (from 1 to 5) in the corresponding selection boxes shown for each condition. Display area 318 indicates that the user has selected all the conditions shown there and has specified corresponding priorities.

It may be appreciated that only a illustrative set of conditions (for forming the desired selection criteria) are shown in display area 310. In alternative embodiments, the set of conditions (and corresponding priorities) provided to the user may vary in number and/or format based on the environment/situation for which the interface of display area 300 is sought to be provided. For example, in one alternative embodiment, a condition may be of the format “PARAM OP VAL”, where TARAM' is a parameter related to a product and/or shopping site, ‘OP’ is a conditional operators such as equal to, less than, greater than and equal to, etc. and ‘VAL’ is a value provided by the user.

Display area 320 (labeled “Items”) enables the user to specify a list of items/products sought to be purchased from the different shopping sites. Each of the products is specified as a corresponding row in table 325, for example, using the “Add” button shown there (which on selection may provide a user interface, not shown here, for adding a product). Each row/product is shown specifying a set of main keywords, an set of optional keywords and the quantity sought to be purchased. Each keyword indicates a quality of the product sought to be purchased, with the main keywords indicating the qualities that define (and accordingly are required in) the product, while the optional keywords merely indicates the qualities that are desirable to the user (and accordingly may not be present in the product selected by shopping tool 150). For example, the second row (shown selected by the “X” mark in the checkbox for that row) indicates that the user wishes to purchase 1 quantity of a “RAM”, that preferably is of the size 2028 Mb (megabytes). The user may also select and remove the desired rows /products from the list using the “Remove” button shown in display area 320.

Display area 330 (labeled “Item Options—RAM”) enables the user to specify various selection criteria for each of the products in table 325. A user may select a desired product/row in table 325 by selecting the corresponding checkbox shown for that row, and then specify the selection criteria for the selected product. Display area 330 is accordingly shown enabling the user to specify the selection criteria for the “RAM” product (as indicated by the label). It should be noted that the options specified in display area 330 overrides the general options specified in display area 310, and accordingly shopping tool 150 is designed to determine the appropriate shopping sites based on the criteria specified in display area 330. In the absence of options specified for an item in display area 330, the general options acts as the default selection criteria (i.e., that applicable when criteria for a product is not otherwise specified) that is applicable for all the list of products.

It may be observed that the user is enabled to specify a different set of criteria and associated priorities for the selected product. Thus, display area 338 indicates that the user has enabled only the three criteria “Highest Discount”, “Positive Review” and “Lowest Price” (with respective priorities 1, 2 and 3) for the “RAM” product. Though not shown, the user may similarly (using the “Websites” option shown in display area 330) specify a different descending order for the sites shown in display area 312 and/or a different set of shopping sites for the “RAM” product. Display area 335 indicates that the user currently possess a coupon that gives the user a “10% discount at Groupon” on the “RAM” product. Other product specific criteria may similarly be specified by the user similar to display area 315.

After the user specifies the desired list of products/items and corresponding different selection criteria for each product, the user selects/clicks “Get Shopping Cart” button 340 to send a (single) request to shopping tool 150 for the listed products. A single request thus implies the data is sent (typically in the form of a single IP packet over network 120, though multiple packets can be used if the size of data warrants it) in response to a single user action, indicating submission of the data to the shopping tool.

In response to the request, shopping tool 150 generates a shopping cart for the listed products based on the user specified criteria. It may be appreciated that a user may specify only a list of items in display area 320 and send such a list of items to shopping tool 150 without any specific selection criteria (either the general options of display area 310 or the item options of display area 330). In such a scenario, shopping tool 150 may generate the shopping cart based on a pre-configured set of shopping sites and a pre-configured set of conditions (for example, Lowest Price with a priority of 1).

Shopping tool 150 then sends the generated shopping cart as a response to the request to the requesting end user system 110A. The received shopping cart may then be provided (displayed) to the user, as described below with examples.

### 5. Shopping Cart

FIG. 3B illustrates the manner in which a user is provided a shopping cart corresponding to a requested list of items and corresponding (different) selection criteria in one embodiment. Display area 350 (similar to display area 300) depicts a portion of a user interface provided on a display unit associated with end user system 110A. Display area 350 corresponds to a webpage (as identified by the text in display area 355) received from shopping tool 150 in response to a user sending a request for a shopping cart, by clicking “Get Shopping Cart” button 340 in FIG. 3A.

Display area 360 (labeled “Selected Options”) indicates the different criteria selected by the user, based on which the shopping cart has been generated. In particular, display area 362 indicates the shopping sites (previously) specified by the user, display area 365 indicates the conditions selected (and the corresponding priority assigned) by the user, and display area 368 indicates any coupons specified by the user. In one embodiment, display area 360 indicates the (general) options specified by the user in display area 310 of FIG. 3A, when no row/product is selected in table 375 (as shown there). In the scenario that the user selects a row/product in table 375, display area 360 indicates the selection criteria specified by the user for the selected product in display area 330 of FIG. 3A.

Display area 370 (labeled “Items”) shows the shopping cart generated for the user specified list (as shown in table 325 of FIG. 3A) and the selection criteria specified for each of the products in the list. The shopping cart is shown in the form of table 375, with each row indicating the details of a corresponding product such as item/product description, the source website/shopping site (from which the product is to be purchased), the unit price, the quantity (as specified by the user in table 325), the total price (computed as unit price x quantity), and any other commercial details that may be of interest for the user/buyer to confirm the purchase.

It may be observed that for the “RAM” product, the shopping cart is shown providing two purchase options (as two corresponding rows of table 375) from two different sellers/shopping sites. The user is enabled to select the desired purchase option from the provided set of options. The user is shown selecting the option to purchase “Kingston 2028 Mb RAM” option. The grand total price of all the products is shown in display area 378. The user may select (using the corresponding checkboxes) select one or more rows/products in table 375 and then click on Remove button to remove the products from the final (purchase) order. The Add button enables the user to later add such removed rows/products and/or to modify the quantity specified for any of the products/items shown in table 375.

After the user is satisfied with the shopping cart, the user selects/clicks “Place Purchase Orders” button 380 to send (from end user system 110A) a confirmation of the shopping cart to shopping tool 150 for the listed products. In a scenario that the user modifies the shopping cart, the modified cart is sent along with the confirmation to shopping tool 150.

In response to the confirmation (and the modified shopping cart), shopping tool 150 places corresponding (purchase) orders for each of the products in the shopping cart at the determined shopping site. As noted above, such placement of orders may require the user to provide payment information in corresponding user interfaces of different shopping sites for completing the purchase at each shopping site. Alternatively, shopping tool 150 may take payment information from the user and provide the information to each of the shopping sites.

Thus, shopping tool 150 facilitates a user to purchase multiple products from different shopping sites according to several aspects of the present invention. The manner in which shopping tool 150 may be implemented is described below with examples.

### 6. Shopping Tool

In one embodiment, shopping tool 150 receives the (single) request in the form of a multi-line text, where each line is of the format “Quantity: Main keywords: Optional keywords: Shopping Sites: Criteria”, where shopping sites is a comma separated list of sites and criteria is of the form “criterion=priority, criterion=priority, . . . ”. Each line is terminated by an end of line (EOL) character, as is well known in the arts.

Thus, in response to the user clicking button 340 in FIG. 3A, the single request may be received with five lines of text corresponding to the five rows/products specified in table 325. The RAM product may be specified in the request as the line “1: RAM: 2028 Mb: www.ebay.com, www.amazon.com, www.groupon.com, www.walmart.com, www.bestbuy.com: Highest Discount=1, Positive Review=2, Lowest Price=3”. Similarly, other lines of text may specify the details of the other products specified by the user.

In response to receiving the request, shopping tool 150 processes each of the products in the received list/line of text. As such, after a selecting a product from the list, shopping tool 150 communicates with each of the shopping sites specified by the user to search and retrieve information on the selected product.

The search performed on a single shopping site may be performed using well known techniques such as HTML (hypertext markup language) parsing, web service request-response, web ontology API (when provided). In HTML parsing, shopping tool 150 retrieves a web page (containing text according to the HTML) provided by a shopping site for the selected product, and then parses the retrieve web page to obtain the details of the product offered by the shopping site. After retrieving the information on the selected product from different shopping sites (using one or more of the techniques noted above), shopping tool 150 then computes a score for each of the shopping sites based on the selection criteria specified by the user.

In one embodiment, shopping tool 150 assigns different weights to each of the criterion (such as “Highest Discount”, “Positive Review”, etc. as shown in display area 318 of FIG. 3A) based on a corresponding priority level specified by said user for the criterion, and then computed the score based on the assigned weights. The computed scores are then used as the basis (e.g., the shopping site with the largest score) for selecting the shopping site satisfying the selection criteria for the selected product. In other words, the selected shopping site is identified as the site from which the selected product is to be purchased and accordingly included in the shopping cart corresponding to the selected product. The manner in which the scores for different shopping sites are computed (and a site best satisfying the criteria selected) for a product is described below with examples.

FIG. 4 illustrates the manner in which a shopping site satisfying the corresponding selection criteria specified for a product is determined in one embodiment. In particular, table 400 illustrates the computations used to determine the shopping site satisfying the selection criteria shown in display area 330 of FIG. 3A for the “RAM” product selected in table 325.

Column 421 specifies the name of each condition, while column 422 specifies a weight assigned to each condition based on the priority level (1-5) assigned by the user. For illustration, the priority levels 1 to 5 are assumed to be assigned the respective weights 1.0, 0.8, 0.6, 0.4 and 0.2. Any condition not selected by the user is assigned a weight of 0, and any user specified coupon is assigned a weight of 1.0. Thus, the conditions “Highest Discount”, “Positive Review” and “Lowest Price” are shown assigned the weights 1.0, 0.8 and 0.6 corresponding to the respective priority levels 1, 2 and 3 assigned by the user in display area 338. The conditions “Running Offers” and “Freshest First” are assigned a weight of 0, since they were not selected by the user. Also, the coupon “10% discount at Groupon” is assigned a weight of 1.0.

Each of columns 423-427 indicates a corresponding shopping site specified by the user. The columns/shopping sites are according to the order specified by the user (in display area 315/330). As such, column 423 corresponds to “www.ebay.com”, while column 427 corresponds to “www.bestbuy.com”. In general, each of the shopping sites specified by the user is represented as a corresponding column in table 400.

Each of rows 441-445 specifies a corresponding condition provided by shopping tool 150 in the interface of FIG. 3A. Row 446 specifies a corresponding coupon/product specific condition specified by a user, in particular, the single coupon specified by the user in display area 335. In general, each of the product specific conditions specified by the user is represented by a corresponding row in table 400. Row 447 specifies a net score for each of the shopping sites represented in the columns 423-427.

Each of the cells (at the intersection of the shopping site columns and condition rows) indicates a score for the respective shopping site for a corresponding condition, and also a value for the condition in square brackets (“[ ]”). For example, the cells in row 443 indicate the scores (9, 7, 10, 10, 8) assigned for the condition “Lowest Price” corresponding to each shopping site, while the value in square brackets indicates the actual price ($42, $45, $38, $38, $42) at which the product is available from the corresponding shopping site. Similarly, other rows indicate respective scores for corresponding condition. It may be observed that all the scores in row 445 are 0, since the condition “Freshest First” is not relevant to the “RAM” product sought to be purchased.

The net score for each shopping site is computed using the formula w1*s1+w2*s2+. . . , where w1, w2, . . . are weights assigned to each condition and s1, s2, . . . are scores for each condition and “*” is the multiplication operator. For example, the net score for the shopping site www.groupon.com is computed as 1.0*7+0*0+0.6*10+0.8*7+0*0+1.0*5=23.6. The net scores for the other shopping sites are similarly computed by shopping tool 150.

A shopping site for purchasing the RAM product is now selected by shopping tool 150 based on the net scores. In one embodiment as noted above, shopping tool 150 identifies the site (that is, www.groupon.com with a score of 23.6) having the largest score as the determined site for the product. Alternatively, shopping tool 150 may select a first site (according to the order of left to right in columns 423-427) having a score above a threshold (for example, 25) as the determined site.

Shopping tool 150 may also select an additional shopping site (such as www.walmart.com) as the additional site has a score that is near (within 10%) of the top scoring site. Shopping tool 150 may then include and provide both the shopping sites as corresponding purchases options for the RAM product, as depicted in display area 370 of FIG. 3B.

The above noted process (noted above with respect to FIG. 4) may be repeated for each of the products in the list of products specified by the user. Shopping tool 150 may accordingly compute the scores, select a suitable shopping site, and then include the suitable shopping site in the generated shopping cart for each of the products in the user-specified list. A total cost (shown in display area 380) for all the products included in the shopping cart is also calculated. The generated shopping cart is then sent to the requesting end user system (110A) to enable the end user system to provide the interface of FIG. 3B.

It should be noted that there may be several scenarios, where shopping tool 150 is unable to find any shopping site matching the user-specified criteria for a product. For example, there may be no site that has products matching all the main keywords, or none of the products satisfy a condition specified by the user. In such scenarios, the products for which sites are unable to be found may be highlighted individually in the shopping cart (table 375), thereby enabling the user to take any necessary steps (change the keywords, criteria, etc.) for finding suitable products.

It should be further appreciated that the features described above can be implemented in various embodiments as a desired combination of one or more of hardware, software, and firmware. The description is continued with respect to an embodiment in which various features are operative when the software instructions described above are executed.

### 7. Digital Processing System

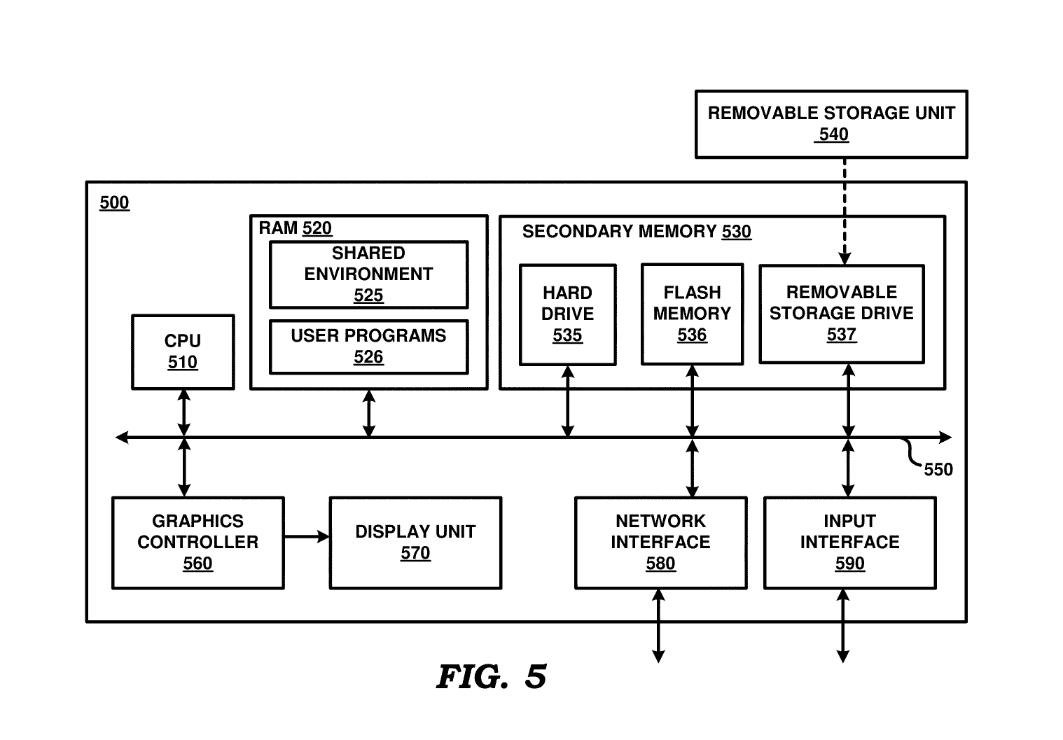

FIG. 5 is a block diagram illustrating the details of digital processing system 500 in which various aspects of the present invention are operative by execution of appropriate software instructions. Digital processing system 500 may correspond to shopping tool 150 or one of end user systems 110A-110X.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present invention. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and/or user programs 526 (such as client applications, Web browser, RDBMS, etc.). Shared environment 525 includes operating systems, device drivers, virtual machines, etc., which provide a (common) run time environment for execution of user programs 526.

Graphics controller 560 generates display signals (e.g., in RGB format) to display unit 570 based on data/instructions received from CPU 510. Display unit 570 contains a display screen to display the images (e.g., portions of the user interface shown in FIGS. 3A-3B) defined by the display signals. Input interface 590 may correspond to a keyboard and a pointing device (e.g., touch-pad, mouse) and may be used to provide inputs (e.g., details of items/products, selection criteria, etc. using user interface shown in FIGS. 3A-3B). Network interface 580 provides connectivity to a network (e.g., using Internet Protocol), and may be used to communicate with other systems (such as those shown in FIG. 1) connected to the network.

Secondary memory 530 may contain hard drive 536, flash memory 537, and removable storage drive 538. Secondary memory 530 may store the data (e.g., portions of the data shown in FIG. 4) and software instructions (e.g., for performing the actions of FIG. 2), which enable digital processing system 500 to provide several features in accordance with the present invention.

Some or all of the data and instructions may be provided on removable storage unit 539, and the data and instructions may be read and provided by removable storage drive 538 to CPU 510. Floppy drive, magnetic tape drive, CD-ROM drive, DVD Drive, Flash memory, removable memory chip (PCMCIA Card, EPROM) are examples of such removable storage drive 538.

Removable storage unit 539 may be implemented using medium and storage format compatible with removable storage drive 538 such that removable storage drive 538 can read the data and instructions. Thus, removable storage unit 539 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 539 or hard disk installed in hard drive 536. These computer program products are means for providing software to digital processing system 500. CPU 510 may retrieve the software instructions, and execute the instructions to provide various features of the present invention described above.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 8. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of facilitating users to purchase multiple products from shopping sites, said method being implemented in a shopping tool, said method comprising:
receiving, from a user, a list of products and a corresponding selection criteria for each of said list of products, wherein a first selection criteria for a first product is different from a second selection criteria for a second product, wherein said first product and said second product are contained in said list of products;
determining, for each of said list of products, a corresponding shopping site satisfying the corresponding selection criteria;
generating a shopping cart indicating, for each of said list of products, the corresponding determined shopping site and a set of commercial terms;
providing said shopping cart as a response to said receiving of said list of products;
receiving, from said user, a confirmation of said shopping cart;
placing corresponding orders for each of said list of products at the corresponding determined shopping site.

2. The method of claim 1, wherein said list of products and the corresponding selection criteria are received as a single request.

3. The method of claim 1, wherein said single request is in the form of a multi-line text, each line of said multi-line text specifying the selection criteria for a corresponding one of said list of products,
wherein each line specifies a quantity of a corresponding product, a set of main keywords defining the corresponding product, a set of optional keywords further qualifying the corresponding product, a list of shopping sites that are to be searched for the corresponding product, and the selection criteria that is to be used for said determining of the shopping site for the corresponding product.

4. The method of claim 2, wherein said determining for said first product comprises:
computing a corresponding score for each of a plurality of shopping sites based on said first selection criteria; and
selecting, based on the corresponding score, one of said plurality of shopping sites as the corresponding shopping site satisfying said first selection criteria.

5. The method of claim 4, wherein said determining for said first product, further comprises:
assigning a weight to each of a plurality of conditions specified as part of said first selection criteria, wherein the weight is assigned based on a corresponding priority level specified by said user for the condition,
wherein said computing computes said corresponding score based on said weights.

6. The method of claim 4, wherein said plurality of shopping sites is also received from said user.

7. The method of claim 2, wherein the corresponding selection criteria for said list of products comprises a default selection criteria applicable to all of said list of products and a specific selection criteria applicable to said first product,
wherein said specific selection criteria overrides said default selection criteria in said determining for said first product such that said specific selection criteria forms said first selection criteria,
wherein said default selection criteria forms said second selection criteria for said second product.

8. The method of claim 7, wherein said shopping cart specifies for each of said list of products, the corresponding determined shopping site, a unit price, and a quantity of the product to be ordered,
wherein said user is provided the ability to form a modified shopping cart by performing one or more of: (a) modifying the corresponding determined shopping site of a desired product, (b) changing the quantity of a desired product, and (c) remove one of said list of products,
wherein said confirmation comprises said modified shopping cart such that said placing places the corresponding orders according to said modified shopping cart.

9. A non-transitory machine readable medium storing one or more sequences of instructions for causing a system to facilitate users to purchase multiple products from shopping sites, wherein execution of said one or more instructions by one or more processors contained in said system causes said system to perform the actions of:
receiving, from a user, a list of products and a corresponding selection criteria for each of said list of products, wherein a first selection criteria for a first product is different from a second selection criteria for a second product, wherein said first product and said second product are contained in said list of products;
determining, for each of said list of products, a corresponding shopping site satisfying the corresponding selection criteria;
generating a shopping cart indicating, for each of said list of products, the corresponding determined shopping site and a set of commercial terms;
providing said shopping cart as a response to said receiving of said list of products;
receiving, from said user, a confirmation of said shopping cart;
placing corresponding orders for each of said list of products at the corresponding determined shopping site.

10. The machine readable medium of claim 9, wherein said list of products and the corresponding selection criteria are received as a single request.

11. The machine readable medium of claim 10, wherein said determining for said first product comprises:
computing a corresponding score for each of a plurality of shopping sites based on said first selection criteria; and
selecting, based on the corresponding score, one of said plurality of shopping sites as the corresponding shopping site satisfying said first selection criteria.

12. The machine readable medium of claim 11, wherein said determining for said first product, further comprises:
assigning a weight to each of a plurality of conditions specified as part of said first selection criteria, wherein the weight is assigned based on a corresponding priority level specified by said user for the condition,
wherein said computing computes said corresponding score based on said weights.

13. The machine readable medium of claim 10, wherein the corresponding selection criteria for said list of products comprises a default selection criteria applicable to all of said list of products and a specific selection criteria applicable to said first product,
wherein said specific selection criteria overrides said default selection criteria in said determining for said first product such that said specific selection criteria forms said first selection criteria,
wherein said default selection criteria forms said second selection criteria for said second product.

14. The machine readable medium of claim 13, wherein said shopping cart specifies for each of said list of products, the corresponding determined shopping site, a unit price, and a quantity of the product to be ordered,
wherein said user is provided the ability to form a modified shopping cart by performing one or more of: (a) modifying the corresponding determined shopping site of a desired product, (b) changing the quantity of a desired product, and (c) remove one of said list of products,
wherein said confirmation comprises said modified shopping cart such that said placing places the corresponding orders according to said modified shopping cart.

15. A digital processing system comprising:
a processor;
a random access memory (RAM);
a machine readable medium to store one or more instructions, which when retrieved into said RAM and executed by said processor causes said digital processing system to facilitate users to purchase multiple products from shopping sites, said digital processing system performing the actions of:
receiving, from a user, a list of products and a corresponding selection criteria for each of said list of products, wherein a first selection criteria for a first product is different from a second selection criteria for a second product, wherein said first product and said second product are contained in said list of products;
determining, for each of said list of products, a corresponding shopping site satisfying the corresponding selection criteria;
generating a shopping cart indicating, for each of said list of products, the corresponding determined shopping site and a set of commercial terms;
providing said shopping cart as a response to said receiving of said list of products;
receiving, from said user, a confirmation of said shopping cart;
placing corresponding orders for each of said list of products at the corresponding determined shopping site.

16. The digital processing system of claim 15, wherein said list of products and the corresponding selection criteria are received as a single request.

17. The digital processing system of claim 16, wherein said determining for said first product comprises:
computing a corresponding score for each of a plurality of shopping sites based on said first selection criteria; and
selecting, based on the corresponding score, one of said plurality of shopping sites as the corresponding shopping site satisfying said first selection criteria.

18. The digital processing system of claim 17, wherein said determining for said first product, further comprises:
assigning a weight to each of a plurality of conditions specified as part of said first selection criteria, wherein the weight is assigned based on a corresponding priority level specified by said user for the condition,
wherein said computing computes said corresponding score based on said weights.

19. The digital processing system of claim 16, wherein the corresponding selection criteria for said list of products comprises a default selection criteria applicable to all of said list of products and a specific selection criteria applicable to said first product,
wherein said specific selection criteria overrides said default selection criteria in said determining for said first product such that said specific selection criteria forms said first selection criteria,
wherein said default selection criteria forms said second selection criteria for said second product.

20. The digital processing system of claim 19, wherein said shopping cart specifies for each of said list of products, the corresponding determined shopping site, a unit price, and a quantity of the product to be ordered,
wherein said user is provided the ability to form a modified shopping cart by performing one or more of: (a) modifying the corresponding determined shopping site of a desired product, (b) changing the quantity of a desired product, and (c) remove one of said list of products,
wherein said confirmation comprises said modified shopping cart such that said placing places the corresponding orders according to said modified shopping cart.
